(19) United States
(12) Patent Application Publication
(10) Pub. No.: US 2020/0219466 A1
(43) Pub. Date: Jul. 9, 2020

(54) PREDICTIVE INTERFACE FOR A CONSOLIDATED VEHICLE INFORMATION CLUSTER

(71) Applicant: SF Motors, Inc., Santa Clara, CA (US)

(72) Inventors: Jaime Camhi, Santa Clara, CA (US); Avery Jutkowitz, Santa Clara, CA (US); Hakuei Huang, Santa Clara, CA (US); Nischitha Mallikarjuna, Santa Clara, CA (US); Ajay Bandi, Santa Clara, CA (US); Joshua Hoffman, Santa Clara, CA (US); Xiaoran Yao, Santa Clara, CA (US)

(21) Appl. No.: 16/243,345

(22) Filed: Jan. 9, 2019

(51) Int. Cl. G09G 5/14; G06N 5/04; B60K 35/00; G06F 3/14

(52) U.S. Cl. CPC G09G 5/14; G06N 5/048; B60K 35/00; B60K 2350/352; G09G 2380/10; G09G 2354/00; G06F 3/1423

(57) ABSTRACT

Provided herein is a consolidated vehicle information system or information cluster. The information cluster can include a vehicle based data processing system to generate a plurality of predictive content items corresponding to a user of a vehicle. The information cluster can include a predictive interface having a plurality of displays to display predictive content items. The vehicle based data processing system can arrange the plurality of predictive content items within the plurality of displays based on relevance scores assigned to the predictive content items. The vehicle based data processing system can receive a first input corresponding to a first predictive content item and identify a first application corresponding to the first predictive content item. The vehicle based data processing system can generate updated relevance scores and modify the arrangement of the predictive content items within the displays based on the updated second relevance scores.

### BACKGROUND

Vehicles can include different information systems to provide information related to the vehicle. The different information systems can be structurally separate and distinct from each other.

### SUMMARY

At least one aspect is directed to a consolidated vehicle information system (e.g., an information cluster). The information cluster can include a vehicle based data processing system to generate a plurality of predictive content items corresponding to a user of a vehicle. The information cluster can include a predictive interface communicatively coupled with the vehicle based data processing system. The predictive interface can include a plurality of displays. Each of the displays can display at least one predictive content item from the plurality of predictive content items. The vehicle based data processing system can arrange the plurality of predictive content items within the plurality of displays based on a first relevance score assigned to each of the predictive content items of the plurality of predictive content items. The vehicle based data processing system can receive a first input corresponding to a first predictive content item of the plurality of predictive content items. The vehicle based data processing system can identify a first application of a plurality of applications. The first application can correspond to the first predictive content item. The vehicle based data processing system can execute the first application. The vehicle based data processing system can generate a second relevance score for each of the predictive content items of the plurality of predictive content items responsive to execution of the first application. The vehicle based data processing system can modify the arrangement of the plurality of predictive content items within the plurality of displays based on the second relevance score assigned to each of the predictive content items of the plurality of predictive content items.

At least one aspect is directed to a method of providing predictive content items within a vehicle information cluster. The method can include generating, by a vehicle based data processing system, a plurality of predictive content items corresponding to a user of a vehicle. The method can include displaying, by a predictive interface, the plurality of predictive content items within a plurality of displays. Each of the displays can display at least one predictive content item from the plurality of predictive content items. The method can include arranging, by the vehicle based data processing system, the plurality of predictive content items within the plurality of displays based on a first relevance score assigned to each of the predictive content items of the plurality of predictive content items. The method can include receiving, by the vehicle based data processing system, a first input corresponding to a first predictive content item of the plurality of predictive content items. The method can include identifying, by the vehicle based data processing system, a first application of a plurality of applications. The first application can correspond to the first predictive content item. The method can include executing, by the vehicle based data processing system, the first application. The method can include generating, by the vehicle based data processing system, a second relevance score for each of the predictive content items of the plurality of predictive content items responsive to execution of the first application. The method can include modifying, by the vehicle based data processing system, the arrangement of the plurality of predictive content items within the plurality of displays based on the second relevance score assigned to each of the predictive content items of the plurality of predictive content items.

At least one aspect is directed to a method. The method can provide a consolidated vehicle information system (e.g., an information cluster). The information cluster can include a vehicle based data processing system to generate a plurality of predictive content items corresponding to a user of a vehicle. The information cluster can include a predictive interface communicatively coupled with the vehicle based data processing system. The predictive interface can include a plurality of displays. Each of the displays can display at least one predictive content item from the plurality of predictive content items. The vehicle based data processing system can arrange the plurality of predictive content items within the plurality of displays based on a first relevance score assigned to each of the predictive content items of the plurality of predictive content items. The vehicle based data processing system can receive a first input corresponding to a first predictive content item of the plurality of predictive content items. The vehicle based data processing system can identify a first application of a plurality of applications. The first application can correspond to the first predictive content item. The vehicle based data processing system can execute the first application. The vehicle based data processing system can generate a second relevance score for each of the predictive content items of the plurality of predictive content items responsive to execution of the first application. The vehicle based data processing system can modify the arrangement of the plurality of predictive content items within the plurality of displays based on the second relevance score assigned to each of the predictive content items of the plurality of predictive content items.

At least one aspect is directed to a vehicle such as an electric vehicle. The electric vehicle can include a consolidated vehicle information system (e.g., an information cluster). The information cluster can include a vehicle based data processing system to generate a plurality of predictive content items corresponding to a user of a vehicle. The information cluster can include a predictive interface communicatively coupled with the vehicle based data processing system. The predictive interface can include a plurality of displays. Each of the displays can display at least one predictive content item from the plurality of predictive content items. The vehicle based data processing system can arrange the plurality of predictive content items within the plurality of displays based on a first relevance score assigned to each of the predictive content items of the plurality of predictive content items. The vehicle based data processing system can receive a first input corresponding to a first predictive content item of the plurality of predictive content items. The vehicle based data processing system can identify a first application of a plurality of applications. The first application can correspond to the first predictive content item. The vehicle based data processing system can execute the first application. The vehicle based data processing system can generate a second relevance score for each of the predictive content items of the plurality of predictive content items responsive to execution of the first application. The vehicle based data processing system can modify the arrangement of the plurality of predictive content items within the plurality of displays based on the second relevance score assigned to each of the predictive content items of the plurality of predictive content items.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram depicting a consolidated vehicle information system having a predictive interface within a vehicle, according to an illustrative implementation;

FIG. 2 is a block diagram depicting a consolidated vehicle information system having a predictive interface disposed within a console of a vehicle, according to an illustrative implementation;

FIG. 3 is a block diagram depicting a first display layout of a predictive interface of a consolidated vehicle information system, according to an illustrative implementation;

FIG. 4 is a block diagram depicting a second display layout of a predictive interface of a consolidated vehicle navigation and information system, according to an illustrative implementation;

FIG. 5 is a flow diagram depicting an example method of providing predictive content items within a vehicle information cluster;

FIG. 6 is a flow diagram depicting an example method of providing predictive content items within a vehicle information cluster; and

FIG. 7 is a block diagram illustrating an architecture for a computer system that can be employed to implement elements of the systems and methods described and illustrated herein, including, for example, the system depicted in FIGS. 1-4, and the methods depicted in FIGS. 5-6.

### DETAILED DESCRIPTION

Following below are more detailed descriptions of various concepts related to, and implementations of a consolidated vehicle navigation and information system for a vehicle, such as electric vehicles. The various concepts introduced above and discussed in greater detail below can be implemented in any of numerous ways.

Systems and methods described herein relate to a predictive interface for a consolidated vehicle information cluster (also referred to herein as an information cluster). The information cluster can include a vehicle based data processing system coupled with a predictive interface having a plurality of displays, with each of the displays displaying at least one predictive content item from a plurality of predictive content items in a consolidated interface. The predictive interface can provide predictive content items to a user of the vehicle (e.g., driver, passenger) that is generated based in part on relevance scores corresponding to the particular user of the vehicle. For example, the vehicle based data processing system can generate the relevance scores based in part on a user profile, user history and user patterns. The predictive content can correspond to different applications and systems of the vehicle. The vehicle based data processing system can generate the predictive content items to include shortcuts to predictive actions for the respective application or system of the vehicle. The shortcuts to identify the predictive actions reduces data processing and memory usage of the vehicle base data processing system, and saves power by more directly identifying the final or predictive action for example by reducing or eliminating back and forth input/output data transactions with an end user. For example, responsive to a selection of at least one predictive content item, the vehicle based data processing system can execute the predictive action (e.g., navigation entries, phone calls, purchase coffee) through the vehicle based data processing system of the vehicle. Thus, the predictive interface can provide a user of the vehicle predictions for different applications or systems of the vehicle to remind the user or predict for the user a next action, such as, a next destination, a next phone number to dial, a next song to listen to, or a next product to buy through a third party vendor. The predictive interface can be provided within the information cluster to consolidate the systems (hardware, software) of the vehicle into a single consolidated interface such that no matter what application is currently executing, for example, in a console of the vehicle, the user of the vehicle can be provided predictive content corresponding to other applications or systems of the vehicle the user typically interacts with while operating the vehicle. Thus, if a first application is executing within the information system, a user of the vehicle can be reminded of an upcoming destination, upcoming phone call, upcoming song, or a product the user typically purchases at that time of day through the predictive interface.

The information interface, as described herein, can display the predictive interface and a plurality of other displays corresponding to different systems of the vehicle within the same common interface to provide a single interface for a user of a vehicle (e.g., driver, passenger) to interact with different systems or applications of the vehicle and be presented predictive content. For example, the information cluster can combine processing power of multiple systems into a single system having a single display to efficiently manage the allocation of computer resources within the vehicle. The consolidated information cluster system can reduce redundant hardware components (e.g., screens, monitors, memory storage or processors) relative to a distributed vehicle information system. This can reduce the weight of the vehicle and increase vehicle range.

The information cluster can include a plurality of displays to display content from different systems of the vehicle and with at least one of the displays dedicated to providing the predictive interface. The predictive interface can include a plurality of displays to provide a plurality of predictive content items generated by the vehicle based processing system. For example, responsive to activating the vehicle, turning the vehicle on or operating the vehicle, the vehicle based data processing system can generate predictive content items for the user of the vehicle and display the predictive content items through the predictive interface. The vehicle based data processing system can generate and provide the predictive interface such that the predictive interface is active and visible within the vehicle when the vehicle is on, in use, or otherwise active. Thus, the information cluster can provide predictive content items through the predictive interface that can be always visible while a user of the vehicle interacts with different, other systems of the vehicle from the same, common display.

The vehicle based data processing system can generate the predictive interface consolidated within the information cluster having interfaces to different systems or applications of the vehicle. Thus, the information cluster can allow a user of the vehicle to interact with the predictive interface and different systems or applications of the vehicle from a single consolidated system. The information cluster can consolidate or combine different processors and logic from multiple systems or components of a vehicle into a single system to more efficiently manage computer resources of the respective vehicle. The information cluster can couple with a single display module having multiple displays to consolidate hardware resources of the respective vehicle. For example, instead of multiple different displays, each of which provide content corresponding to different systems of the vehicle, the information clusters as described herein can provide a single system with a single display module to provide content and predictive content from each of the different systems of the vehicle and the predictive interface. Thus, separate displays, panels, processors, or logic can be eliminated or reduced to more efficiently manage the computer resources (e.g., software, hardware) of the respective vehicle. The information cluster can improve computer resource allocation by eliminating or reducing the amount of separate and distinct processors and hardware elements for vehicle systems that may be used sparingly reducing vehicle weight and increasing vehicle range. Thus, conserving and efficiently allocating computer resources of the respective vehicle through the information cluster. The information cluster can include a touch screen display to provide an input device via the display module in a common location such that the user of the vehicle can interact with the different systems and predictive interface of the vehicle from a single vantage point. This can help to conserve computer resources, and may avoid or eliminate different systems of the vehicle each having independent input devices for a user of the vehicle to interact with the respective system of the vehicle.

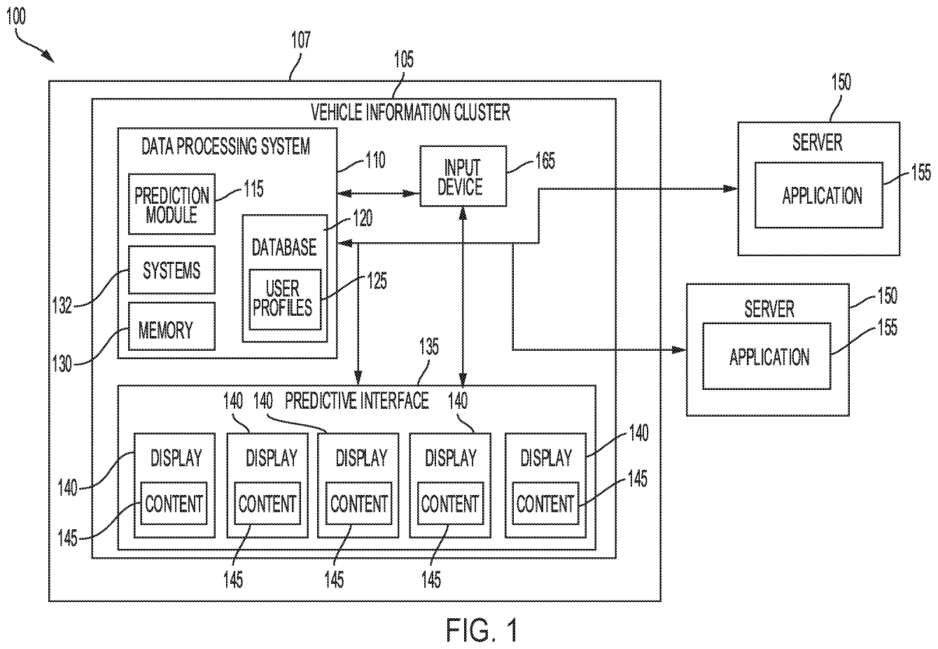

FIG. 1, among others, depicts a view 100 of a block diagram of a predictive interface for a consolidated vehicle information cluster 105 (e.g., an information cluster) for a vehicle 107. The vehicle 107 can include a configuration, arrangement or network of electrical, electronic, mechanical or electromechanical devices within a vehicle of any type. The vehicle 107 can include automobiles, cars, trucks, passenger vehicles, industrial vehicles, motorcycles, and other transport vehicles. The vehicle 107 can include electric vehicles, electric automobiles, cars, motorcycles, scooters, passenger vehicles, passenger or commercial trucks, and other vehicles such as sea or air transport vehicles, planes, helicopters, submarines, boats, or drones. The vehicle 107 can be fully autonomous, partially autonomous, or unmanned. Thus, the vehicle 107 can include an autonomous, semi-autonomous, or non-autonomous human operated vehicle. The vehicle 107 can include a hybrid vehicle that operates from on-board electric sources and from gasoline or other power sources. The vehicle 107 can include an electric vehicle (EVs), hybrid vehicle, fossil fuel vehicle, a car, a truck, motorcycles, scooters, passenger vehicles, passenger or commercial trucks, and other vehicles such as sea or air transport vehicles, planes, helicopters, submarines, boats, or drones. The EV s can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned.

The information cluster 105 can couple multiple different systems, including a predictive interface 135, or other applications executing within, executing on the vehicle 107 or external to the vehicle 107 (e.g., third party servers, servers 150) within a single system to conserve and more efficiently allocate computer resources of the respective vehicle 107 through the information cluster 105. The information cluster 105 can include a vehicle based data processing system 110 (e.g., DPS). The vehicle based data processing system 110 can include a prediction module 115, a database 120 having user profiles 125, and a memory 130. The vehicle based data processing system 110 can be implemented using hardware or a combination of software and hardware. For example, each component of the vehicle based data processing system 110 can include logical circuity (e.g., a central processing unit or CPU) that responses to and processes instructions fetched from a memory unit (e.g., memory 130). Each component of the vehicle based data processing system 110 can include or use a microprocessor or a multi-core processor. A multi-core processor can include two or more processing units on a single computing component. Each component of the vehicle based data processing system 110 can be based on any of these processors, or any other processor capable of operating as described herein. Each processor can utilize instruction level parallelism, thread level parallelism, or different levels of cache, for example. For example, the vehicle based data processing system 110 can include at least one logic device such as a computing device or server having at least one processor to communicate via a network with one or more systems of the vehicle 107. The components and elements (e.g., database 120, memory 130) of the vehicle based data processing system 110 can be separate components, a single component, or part of the vehicle based data processing system 110. For example, the database 120 and the memory 130) can include combinations of hardware and software, such as one or more processors configured to initiate stop commands, initiate motion commands, and transmit or receive timing data, for example.

The prediction module 115 can be implemented using hardware or a combination of software and hardware. For example, the prediction module 115 can include logical circuity (e.g., a central processing unit or CPU) that responses to and processes instructions fetched from a memory unit (e.g., memory 130). The prediction module 115 can include a prediction algorithm for generating predictive content item 145. For example, the prediction algorithm can include a function or set of instructions to identify at least one user profile 125 of the plurality of user profiles 125 stored in the database 120 responsive to identifying a user of the vehicle 107 (e.g., driver, passenger). The prediction algorithm can include a function or set of instructions to extract data from the identified user profile 125 corresponding to a system 132 of the vehicle 107. For example, the prediction module 115 can execute the prediction algorithm to extract systems 132 the user interacts with above a relevance threshold (e.g., once a day, once a week, every time the user is in the vehicle). The prediction module 115 can execute the prediction algorithm to identify actions the user requested or performed using the extracted systems 132. The prediction module 115 can execute the prediction algorithm to generate predictive actions corresponding to the users past history using the data from the corresponding user profile. The predictive actions can be linked with at least one predictive content item 145. The prediction module 115 can execute the prediction algorithm to provide the predictive content item 145 within displays 140 of the predictive interface 135.

The database 120 can include a structured set of data stored for the vehicle based data processing system 110. The database 120 can couple with the memory 130 to store and retrieve data, such as, user actions, user profiles 125, content items 145, systems 132, application requests, points of interest, display properties (e.g., displays 140), contact inputs, touch inputs, audio inputs, geographical information, vehicle information, command instructions, vehicle status information, environmental information within or external to the vehicle, road status or road condition information, vehicle location information or other information during execution of instructions by the vehicle based data processing system 110. The memory 130 can include a random access memory (RAM) or other dynamic storage device, coupled with the vehicle based data processing system 110 for storing information, and instructions to be executed by the vehicle based data processing system 110. The memory 130 can be used for storing user actions, user profiles 125, content items 145, systems 132, application requests, points of interest, display properties (e.g., displays 140), contact inputs, touch inputs, audio inputs, geographical information, vehicle information, command instructions, vehicle status information, environmental information within or external to the vehicle, road status or road condition information, vehicle location information or other information during execution of instructions by the vehicle based data processing system 110. The memory 130 can include at least one read only memory (ROM) or other static storage device coupled with the vehicle based data processing system 110 for storing static information and instructions for the vehicle based data processing system 110. The memory 130 can include a storage device, such as a solid state device, magnetic disk or optical disk, coupled with the vehicle based data processing system 110 to persistently store information and instructions.

The vehicle based data processing system 110 can generate predictive content item 145 to display within displays 140 of the predictive interface 135. For example, the vehicle based data processing system 110 can execute the prediction module 115 to generate the predictive content item 145. The vehicle based data processing system 110 can determine relevance scores for the different predictive content item 145 based in part on at least one of: a time value, a location of the vehicle 107, a pattern profile of the user of the vehicle 107, and a user profile of the user of the vehicle 107. The vehicle based data processing system 110 can generate instructions to arrange the predictive content items 145 within the plurality of displays 140 of the predictive interface 135 based on the relevance scores. The vehicle based data processing system 110 can modify the arrangement of the predictive content items 145 within the plurality of displays 140 of the predictive interface 135 responsive to an input from a user of the vehicle 107. For example, the vehicle based data processing system 110 can arrange the plurality of predictive content items 145 within the plurality of displays 140 based on a first relevance score assigned to each of the predictive content items 145 of the plurality of predictive content items 145. The vehicle based data processing system 110 can receive a first input corresponding to a first predictive content item 145 of the plurality of predictive content items 145. For example, the user of the vehicle 107 can select the first predictive content item 145. Responsive to the first input, the vehicle based data processing system 110 can identify a first application 155 of a plurality of applications 155 hosted by a plurality of servers 150. The first application 155 can correspond to the first predictive content item 145. The vehicle based data processing system 110 can generate instructions to execute the first application 155. The vehicle based data processing system 110 can generate a second relevance score for each of the predictive content items 145 of the plurality of predictive content items 145 responsive to execution of the first application 155. The vehicle based data processing system 110 can generate instructions to modify the arrangement of the plurality of predictive content items 145 within the plurality of displays 140 based on the second relevance score assigned to each of the predictive content items 145 of the plurality of predictive content items 145. Thus, the vehicle based data processing system 110 can dynamically modify predictive content items 145 based in part on a user of the vehicle 107 or an input from a user of the vehicle 107.

The predictive interface 135 can include a plurality of displays 140 to provide predictive content items 145 to a user of the vehicle 107. The predictive interface 135 can be consolidated within the information cluster 105 to provide a visual interface for a user of the vehicle 107 to interact with the different systems or applications 155 of the vehicle 107 from the single information cluster 105. For example, the user can be provided access to the predictive interface 135, a navigation menu, a climate control menu, an entertainment menu, an autonomous drive menu, or a phone menu through different displays 140 of the information cluster 105. Thus, the information cluster 105 as described herein can reduce or eliminate the need for any specific button layout, independent hardware, independent software for each of the different systems of the vehicle 107 as they can be provided within the single information cluster 105 and share a common vehicle based data processing system 110. The information cluster 105 can provide a consistent and easily accessible control interface for any context the user may want to interface with in the vehicle 107 directly from, for example but not limited to, a console of the vehicle 107.

The information cluster 105 can include a plurality of displays 140 to provide content items 145 corresponding to different systems 132 of the vehicle 107 (e.g., climate control system 132, entertainment system 132, navigation system 132). The displays 140 can display at least one predictive content item 145. For example, a group or number of displays 140 of the information cluster 105 can be assigned to or allocated to the predictive interface 135 to display predictive content items 145. The vehicle based data processing system 110 can generate the displays 140 allocated to the predictive interface 135 such that the predictive interface 135 is always visible to a user of the vehicle 107 when the vehicle 107 is active otherwise turned on. The predictive interface 135 can provide a plurality of predictive content items 145 through the displays 140 allocated to the predictive interface 135. The predictive content items 145 can include data structures saved in a database (e.g., database 120) of the information cluster 105 or a database separate from but communicatively coupled with the information cluster 105. The predictive content items 145 can correspond to a system 132 of the vehicle 107. For example, the predictive content items 145 can be linked with a navigation system, a climate control system, an entertainment system, an autonomous drive system, or a phone system of the vehicle 107. The predictive content items 145 can correspond to any system, component or element of the vehicle 107 or any system, component or element coupled with the vehicle 107 (e.g., cell phone, computing device, electronic key). The predictive content items 145 can correspond to a service or product provided by at least one application 155 hosted by an external server 150. Thus, the predictive content items 145 can be linked with or include at least one link to an external server 150 to request to retrieve content corresponding to a respective predictive content items 145. For example, the vehicle based data processing system 110 can generate at least one hyperlink for each of the plurality of predictive content items 145 provided within the predictive interface 135. The vehicle based data processing system 110 can generate the plurality of predictive content items 145 such that each of the predictive content items 145 include a hyperlink or are tagged with a hyperlink to redirect a user of the vehicle from the predictive interface 135 to a server 150 corresponding to the respective content item 145.

The predictive interface 135 can provide a visual output or an audio output from the vehicle based data processing system 110, the vehicle 107 or other forms of computing device content to a user of the vehicle 107 through the plurality of displays 140. For example, the predictive interface 135 can provide a visual feedback output from the vehicle based data processing system 110 to a user of the vehicle 107 through the plurality of displays 140. The displays 140 can include an electronic device for the visual presentation of data, such as but not limited to, content items 145. The displays 140 (e.g., display windows) can include an interface, a screen, a digital window, or display device to provide a visual display to a user of the vehicle 107. The displays 140 can correspond to portions of the predictive interface 135 generated by the vehicle based data processing system 110. The predictive interface 135 and each of the plurality of displays 140 can include a touch screen. For example, the predictive interface 135 and each of the plurality of displays 140 can receive a contact or touch input via a screen of the respective display 140 and generate a signal corresponding to the contact input or user input. Thus, the predictive interface 135 and each of the plurality of displays 140 can provide an interface for a user to interact with through contact.

The dimensions of the displays 140 can vary based at least in part on a location within a vehicle 107 that the displays 140 are disposed or provided. Each of the displays 140 can have the same dimensions. One or more of the displays 140 can have different (e.g., greater, less than) dimensions that one or more other displays 140. The dimensions of the displays 140 can be dynamically modified by the vehicle based data processing system 110. For example, the vehicle based data processing system 110 can generate the displays 140 for the predictive interface 135. The vehicle based data processing system 110 can determine a number of displays 140 to provide within the predictive interface 135 based in part on the dimensions of the predictive interface 135 or a user of the vehicle. The vehicle based data processing system 110 can determine dimensions (e.g., diameter, radius, length, width) of the predictive interface 135 and the displays 140. The vehicle based data processing system 110 can determine a number of pixels within the predictive interface 135 to allocate to each of the displays 140. The dimensions or pixel value assigned to a display 140 can be selected based at least in part on a content item 145 to be provided within the respective display 140. The vehicle based data processing system 110 can determine a position for each of the displays 140 within the predictive interface 135. The vehicle based data processing system 110 can generate and assign content items 145 to each of the displays 140. The vehicle based data processing system 110 can position and relocate the content items 145 between each of the displays 140, for example, responsive to a user of the vehicle 107 or responsive to an input received through one of the displays 140. For example, the vehicle based data processing system 110 can relocate or move a first content item 145 from a first display 140 of the plurality of displays 140 to a second, different display 140 of the plurality of displays 140. The information cluster 105 and the predictive interface 135 can be disposed within or provided within various components of the vehicle 107. For example, but not limited to, the information cluster 105, the predictive interface 135 and the plurality of displays 140 can be disposed within or provided within a dashboard, a console, a steering wheel, or a seat (e.g., head rest, back portion) of the vehicle 107. The predictive interface 135 can include two or more displays 140. The predictive interface 135 can include a single display 140. The predictive interface 135 can provide a visual or audio output from the vehicle based data processing system 110, the vehicle 107 or other forms of computing device content to a user of the vehicle 107.

The information cluster 105 can include or couple with at least one input device 165. The input device 165 can include a device, a human interface device, a computing device or computing element to receive and provide data and control signals to the vehicle based data processing system 110. For example, the input device 165 can provide data and control signals to the vehicle based data processing system 110 responsive to a selection of a content item 154 of the predictive interface 135. The input device 165 can generate the control signal responsive to, but not limited to, a physical motion, mechanical motion, or audio input. For example, the input device 165 can generate a control signal responsive to contact (e.g., physical contact) with a surface of the input device 165. The input device 165 can generate the control signal responsive to, but not limited to, a touching, a pressing, a swipe motion or other forms of contact with the surface of the input device 165. The contact can include discrete contact or continuous contact. The input device 165 can include a keypad, a layout of buttons or group of buttons. For example, the buttons can generate a signal responsive to at least one of a contact input, a physical motion input, a mechanical motion input, and an audio input. The input device 165 can include two or more buttons. The input device 165 can include a single button. The buttons can include mechanical buttons (e.g., spring based buttons), digital buttons or virtual buttons. The input device 165 can be provided on or couple with different portions of the vehicle 107. For example, the input device 165 can be provided on or couple with a steering wheel, a console or a dashboard of the vehicle 107.

The information cluster 105 can couple with at least one server 150 that hosts or provides at least one application 155. The servers 150 can include remote servers or third party servers executing external to the vehicle 107 or the vehicle based data processing system 110. For example, the servers 150 may include an application delivery system for delivering an application 155, a computing environment, and/or data files to the vehicle based data processing system 110. The servers 150 can include HTTP servers or application servers. The servers 150 can correspond to vendors, stores, destinations, home address, schools, offices, shopping centers, coffee shops, grocery stores, or environmental destinations (e.g., park, lake, mountain). For example, one or more of the content items 145 displayed within the predictive interface 135 can be linked with at least one server 150 to retrieve data corresponding to the respective content item 145. For example, a content item 145 can correspond to a coffee shop. The coffee shop content item 145 can be linked, for example, using a hyperlink, with a web address of the corresponding coffee shop hosted by at least one server 150. The vehicle based data processing system 110 can request or retrieve data from the servers 150 to generate one or more of the content items 145. For example, responsive to an input from a user of the vehicle 107, the vehicle based data processing system 110 can generate a request for data from a server 150 corresponding to or linked with a selected content item 145 that the user interacted with through the predictive interface 135.

The vehicle based data processing system 110 can generate a function (e.g., set of instructions) to include with a request to the third party server. The function can cause the third party application to generate data corresponding to the selected content item 145. For example, in the coffee shop content item 145 example, the function can include a set of instructions to cause the third party server to retrieve menu data and price data for coffee supplied by the respective coffee shop. The vehicle based data processing system 110 can receive the data corresponding to the content item 145 (e.g., coffee menu with coffee prices) and display the content item 145 within the predictive interface 135.

The servers 150 can provide or host at least one application 155. The applications 155 can correspond to a point of service tool corresponding to a predictive content item 145. For example, the applications 155 can include a home page or web content corresponding to a predictive content item 145. The applications 155 may include web content, HTTP content or resources provided by or hosted by the servers 150. For example, the applications 155 may include network applications that are served from and/or hosted on the servers 150. The applications 155 can include an application hosted on at least one server 150 accessed by the vehicle based data processing system 110 via a network. The applications 155 can include, but not limited to, a web application, a desktop application, remote-hosted application, a virtual application, a mobile application, an HDX application, a local application, or a native application (e.g., native to the vehicle based data processing system 110 or vehicle 107). The vehicle based data processing system 110 and the servers 150 can be communicatively coupled through a network, such as but not limited to, a public network, a wide area network (WAN) or the Internet. The network may be a private network such as a local area network (LAN) or a company Intranet. The network may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

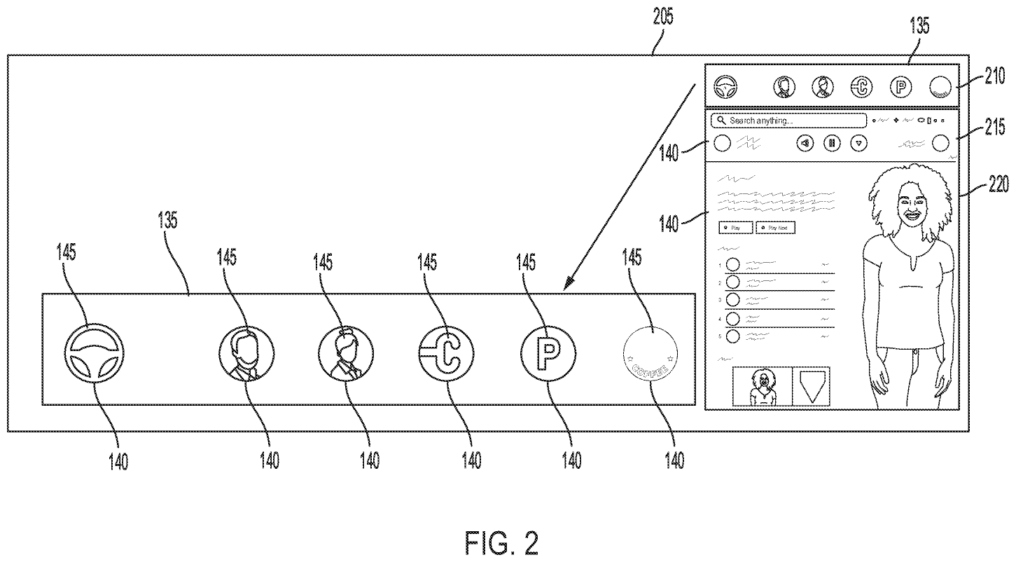

FIG. 2, among others, depicts an information cluster 105 provided within a console 205 of a vehicle 107. The information cluster 105 can include a plurality of displays 140 to provide menus or applications corresponding to different systems 132 of the vehicle 107 through a single consolidated display. Thus, the information cluster 105 can combine processing power of multiple systems into a single system to efficiently manage the allocation of computer resources within the vehicle 107. For example, the information cluster 105 can include a first portion 210 providing a predictive interface 135. The predictive interface can include a plurality of displays 140 allocated to the predictive interface 135 by the vehicle based data processing system 110. The information cluster 105 can include a second portion 215 providing a search system 132 within a display 140. The information cluster 105 can include a third portion 220 providing an entertainment system 132 within a display 140. The vehicle data processing system can generate the predictive interface 135 such that the predictive interface 135 is displayed at all times when the vehicle 107 is active, turned on or otherwise in use.

The vehicle based data processing system 110 can allocate a number of displays 140 to the predictive interface 135 to display predictive content items 145. The vehicle based data processing system 110 can select the number of displays 140 to allocate to the predictive interface 135 based in part on the number of predictive content items 145 to display to a user of the vehicle 107 and the dimensions of the information cluster 105. For example, and as depicted in FIG. 2, the vehicle based data processing system 110 can allocate six displays 140 to the predictive interface 135. The first display 140 of the predictive interface can provide a first predictive content item 145 corresponding to a navigation system 132. The second display 140 of the predictive interface can provide a first predictive content item 145 corresponding to a first contact in a phone system 132. The third display 140 of the predictive interface can provide a third predictive content item 145 corresponding to a second contact in the phone system 132. The fourth display 140 of the predictive interface can provide a fourth predictive content item 145 corresponding to a charging application 155. The fifth display 140 of the predictive interface can provide a fifth predictive content item 145 corresponding to a parking application 155. The sixth display 140 of the predictive interface can provide a sixth predictive content item 145 corresponding to a coffee application 155.

The vehicle based data processing system 110 can generate a standard display layout for the information cluster 105 and the predictive interface 135. For example, when the vehicle 170 is turned on, the vehicle based data processing system 110 can initially display a standard display layout having a plurality of displays 140 and a number of the displays 140 allocated to the predictive interface 135. The standard display layout can correspond to a factory setting or setting selected by a user or owner of the vehicle 107. The vehicle based data processing system 110 can generate a custom display layout or modify display layout properties responsive to inputs or interactions from a user of the vehicle 107. For example, the vehicle based data processing system 110 can generate custom display layouts that are unique to each user of the vehicle 107. The custom display layout settings can be stored in the memory 130 of the vehicle based data processing system. The vehicle based data processing system 110 can identify a user of the vehicle 107 when the vehicle is turned on and identify a custom display layout for the user of the vehicle 107. The vehicle based data processing system 110 can dynamically update or modify the custom display layout responsive to user inputs or user interactions with the respective custom display layout. For example, the vehicle based data processing system 110 can monitor how many predictive interface content items 145 the user interacts with to determine how many displays 140 to allocate to the predictive interface 135. The vehicle based data processing system 110 can update a user profile of the respective user to reflect that the user prefers to have, for example, six predictive content items 145 provided within six displays 140 of the predictive interface 135. The number of displays 140 allocated to the predictive interface 135 can be less than six (e.g., one display 140, more than one display 140) or greater than six (e.g., seven displays 140, ten displays 140). The vehicle based data processing system 110 can continually update or dynamically modify user profiles to reflect user inputs or user interactions with a custom display layout corresponding to the user.

The dimensions of the displays 140 or portions 210, 215, 220 can vary based at least in part on a location within a vehicle 107 that the information cluster 105 is disposed or provided. The vehicle based data processing system 110 can generate the displays 140 or portions 210, 215, 220 having varying dimensions or the same dimensions to fit or position within the component of the vehicle the information cluster 105 is disposed within (e.g., console, dashboard). For example, the vehicle based data processing system 110 can generate the information cluster 105 having three displays 140 of varying dimensions. A first display 140 can have a height or length in a range from 1 inch to 4 inches (e.g., 1.7 inches) and a width in a range from 7 inches to 12 inches (e.g., 9 inches). A second display 140 can have a height or length in a range from 0.5 inches to 4 inches (e.g., 0.75 inches) and a width in a range from 7 inches to 12 inches (e.g., 9 inches). A third display 140 can have a height or length in a range from 2 inches to 10 inches (e.g., 5 inches) and a width in a range from 7 inches to 12 inches (e.g., 9 inches). The height, length and width of the displays 140 can vary within or outside these ranges. The vehicle based data processing system 110 can generate the displays 140 based on or using pixel values. The vehicle based data processing system 110 can generate the displays 140 having varying heights or lengths and the same width. The vehicle based data processing system 110 can generate the displays 140 having the same height or length and varying widths. The vehicle based data processing system 110 can generate the displays 140 having varying heights or lengths and varying widths.

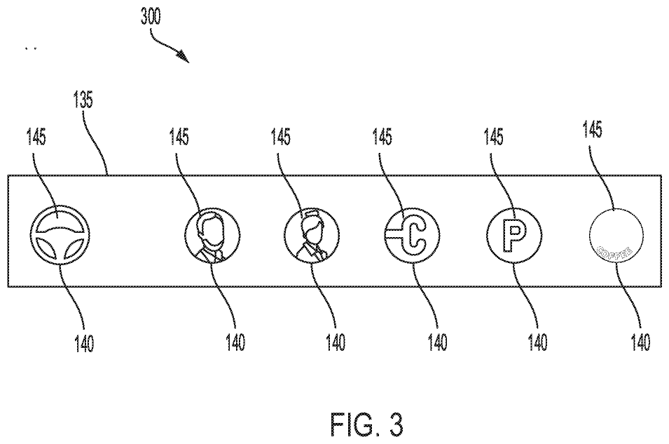

FIG. 3, among others, depicts a display layout 300 of a predictive interface 135 of an information cluster 105 provided within a console 205 of a vehicle 107. The display layout 300 of the predictive interface 135 can include a first display 140 providing a first predictive content item 145 corresponding to a navigation system 132 of the vehicle 107. The vehicle based data processing system can generate the first display 140 having a first set of dimensions (or first pixel value). The display layout 300 of the predictive interface 135 can include a second display 140 providing a second predictive content item 145 corresponding to a first contact through a phone system 132 of the vehicle 107. The vehicle based data processing system can generate the second display 140 having a second set of dimensions (or second pixel value). The display layout 300 of the predictive interface 135 can include a third display 140 providing a third predictive content item 145 corresponding to a second contact through the phone system 132 of the vehicle 107. The vehicle based data processing system can generate the third display 140 having a third set of dimensions (or third pixel value). The display layout 300 of the predictive interface 135 can include a fourth display 140 providing a fourth predictive content item 145 corresponding to a charging application 155 to aid a user of the vehicle in identifying charging stations within the geographical location of the vehicle 107 (e.g., electric vehicle). The vehicle based data processing system can generate the fourth display 140 having a fourth set of dimensions (or fourth pixel value). The display layout 300 of the predictive interface 135 can include a fifth display 140 providing a fifth predictive content item 145 corresponding to a parking application 155 to aid a user of the vehicle in identifying parking locations (e.g., parking spots, parking garages) within the geographical location of the vehicle 107. The vehicle based data processing system can generate the fifth display 140 having a fifth set of dimensions (or fifth pixel value). The display layout 300 of the predictive interface 135 can include a sixth display 140 providing a sixth predictive content item 145 corresponding to a coffee application 155 for a local coffee shop the user of the vehicle 107 visits frequently. The vehicle based data processing system can generate the sixth display 140 having a sixth set of dimensions (or sixth pixel value).

The vehicle based data processing system 110 can generate the dimensions for each of the displays 140 based on a standard display layout settings or a custom display layout settings corresponding to a user of the vehicle 107. The dimensions can correspond to a length value, width value, diameter value, or a combination of a length value and a width value. The dimensions can correspond to a pixel value assigned or allocated to the displays 140 by the vehicle based data processing system 110. The vehicle based data processing system 110 can determine the dimensions based in part on the dimensions of the console 205 the information cluster 105 is provided within. For example, the vehicle based data processing system 110 can generate each of the displays 140 such that the displays 140 are visible or at least partially visible within the vehicle 107 with respect to a viewpoint of a user of the vehicle 107. The vehicle based data processing system 110 can generate a set of instructions corresponding to each display 140 to generate each of the displays 140 having the determined dimensions or pixel values. For example, the instructions can include the dimensions or pixel values for each of the displays 140 to be generated. The vehicle based data processing system 110 can generate each of the displays 140 of the predictive interface 135 having the same visibility (e.g., same dimensions, same pixel value). The vehicle based data processing system 110 can generate one or more of the displays 140 of the predictive interface having a different visibility (e.g., same dimensions, same pixel value) from one or more other displays 140. The predictive interface 135 can receive the set of instructions from the vehicle based data processing system 110 and generate or provide each of the displays 140 using the instructions having the dimensions or pixel values for each of the displays 140 to be generated.

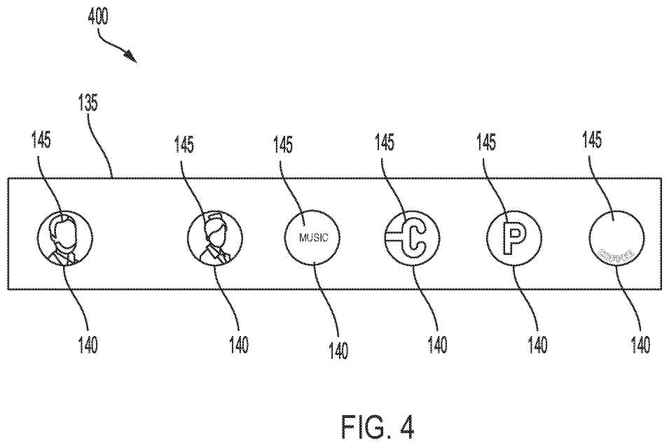

FIG. 4, among others, depicts a display layout 400 of a predictive interface 135 of an information cluster 105 provided within a console 205 of a vehicle 107. The display layout 400 can be generated by the vehicle based data processing system 110 responsive to a selection of the first predictive content item 145 corresponding to the navigation system 132 and provided within the first display 140. For example, in FIG. 4, the display layout 400 does not include the first predictive content item 145 corresponding to the navigation system 132. Responsive to the user input corresponding to the selection of the first predictive content item 145 corresponding to the navigation system 132, the vehicle based data processing system 110 can modify the display layout 300. The vehicle based data processing system 110 can identify the predictive content item 145 that has been selected by a user and remove the respective predictive content item 145, here the first predictive content item 145, from the displays 140 allocated to the predictive interface 135 within the information cluster 105. The vehicle based data processing system 110 can update or generate new relevance scores for the predictive content items 145 not including the selected first predictive content item 145. Responsive to generating new or updated relevance scores, the vehicle based data processing system 110 can identify the six predictive content items 145 corresponding to the user of the vehicle 107 having the highest or six highest relevance scores. The vehicle based data processing system 110 can select the six predictive content items 145 having the six highest relevance scores based in part on the predictive interface 135 being allocated six displays 140. The vehicle based data processing system 110 can generate instructions to display the six predictive content items 145 having the six highest relevance scores. A display 140 of the display 140 allocated to the predictive interface 135 can be selected for each of the six predictive content items 145 based in part on the respective relevance score. For example, the vehicle based data processing system can assign the predictive content item 145 having the highest relevance score to the first display 140. The vehicle based data processing system can assign the predictive content item 145 having the second highest relevance score to the second display 140. the vehicle based data processing system can assign the predictive content item 145 having the third highest relevance score to the third display 140. The vehicle based data processing system can assign the predictive content item 145 having the fourth highest relevance score to the fourth display 140. The vehicle based data processing system can assign the predictive content item 145 having the fifth highest relevance score to the fifth display 140. The vehicle based data processing system can assign the predictive content item 145 having the sixth highest relevance score to the sixth display 140. The vehicle based data processing system 110 can execute instructions to display each of the six predictive content items 145 in the assigned display.

The display layout 400 of the predictive interface 135 can include a first display 140 providing a first predictive content item 145 corresponding to a first contact through a phone system 132 of the vehicle 107. The vehicle based data processing system can generate the first display 140 having a first set of dimensions (or first pixel value). The display layout 400 of the predictive interface 135 can include a second display 140 providing a second predictive content item 145 corresponding to a second contact through the phone system 132 of the vehicle 107. The vehicle based data processing system can generate the second display 140 having a second set of dimensions (or second pixel value). The display layout 400 of the predictive interface 135 can include a third display 140 providing a third predictive content item 145 corresponding to an entertainment system 132 of the vehicle 107. The third predictive content item 145 corresponding to the entertainment system 132 can be a new predictive content item 145 that was not included in the display layout 300 of FIG. 3. For example, the vehicle based data processing system 110 can select the third predictive content item 145 corresponding to the entertainment system 132 for display responsive to updating the relevance scores of the predictive content items 145. The vehicle based data processing system can move the second and third predictive content items 145 from display layout 300 at least one display 140 responsive to the updating the relevance scores of the predictive content items 145. Thus, the second and third predictive content items 145 from display layout 300 can be displayed in the first and second displays140 of the display layout 400 of FIG. 4 responsive to the selection of the previous first predictive content item 145 and the updated relevance scores.

The display layout 400 of the predictive interface 135 can include a fourth display 140 providing a fourth predictive content item 145 corresponding to a charging application 155. The vehicle based data processing system can generate the fourth display 140 having a fourth set of dimensions (or fourth pixel value). The display layout 300 of the predictive interface 135 can include a fifth display 140 providing a fifth predictive content item 145 corresponding to a parking application 155. The vehicle based data processing system can generate the fifth display 140 having a fifth set of dimensions (or fifth pixel value). The display layout 300 of the predictive interface 135 can include a sixth display 140 providing a sixth predictive content item 145 corresponding to a coffee application 155. The vehicle based data processing system can generate the sixth display 140 having a sixth set of dimensions (or sixth pixel value). Thus, the vehicle based processing system can determine that the fourth, fifth and sixth predictive content items 145 of the display layout 300 of FIG. 3 can remain in the same position in the display layout of FIG. 4 responsive to the selection of the first predictive content item 145 and the updated relevance scores. The vehicle based data processing system 110 can continually monitor and dynamically modify the predictive content items 145 provided within the predictive interface 135 responsive to user inputs and interactions.

The vehicle based data processing system 110 can determine to modify dimensions of the displays 140 responsive to user inputs or interactions. For example, the vehicle based data processing system 110 can generate a set of instructions to modify the dimensions of one or more displays 140 allocated to the predictive interface 135. The vehicle based data processing system 110 can generate a set of instructions to reduce the size of the sixth display 140 providing the sixth predictive content item 145. The instructions to reduce the size of the sixth display 140 (or any display 140) can include a new set of dimensions that include smaller dimensions (e.g., smaller width, smaller length, smaller diameter) as compared to the dimensions the sixth display 140 was assigned in the display layout 300 of FIG. 3. The instructions to reduce the size of the sixth display 140 (or any display 140) can include a new pixel value that includes less pixels than the pixel value assigned to the sixth display 140 in the display layout 300 of FIG. 3. The vehicle based data processing system 110 can reduce the size of the sixth predictive content item 145 in the sixth display 140 by various amounts based in part on the size of the other displays 140 allocated to the predictive interface 135. For example, the vehicle based data processing system 110 can reduce the size of the sixth predictive content item 145 in the third display 140 by 10%. The vehicle based data processing system 110 can reduce the size of the sixth predictive content item 145 in the sixth display 140 by 50%. The vehicle based data processing system 110 can remove the sixth predictive content item 145 from the sixth display 140 or remove the sixth display 140 and thus, reduce the size of the sixth predictive content item 145 in the sixth display 140 or the sixth display 140 by 100%. The vehicle based data processing system 110 can reduce the size of a display 140 allocated to the predictive interface in a range from 5% to 100%.

The vehicle based data processing system 110 can generate a set of instructions to increase the size of the first display 140 of the predictive interface 135. The instructions to increase the size of the first display 140 (or any display 140) can include a new set of dimensions that include larger dimensions (e.g., greater width, greater length, greater diameter) as compared to the dimensions the first display 140 was assigned in the display layout 300 of FIG. 3. The instructions to increase the size of the first display 140 (or any display 140) can include a new pixel value that includes more pixels than the pixel value assigned to the first display 140 of the predictive interface 135 in the display layout 300 of FIG. 3. The vehicle based data processing system 110 can increase the size of the first display 140 or the first predictive content item 145 provided in the first display 140 by various amounts based in part on the size of the other displays 140 allocated to the predictive interface 135. For example, the vehicle based data processing system 110 can increase the size of the first display 140 or the first predictive content item 145 provided in the first display 140 by 10%. The vehicle based data processing system 110 can increase the size of the first display 140 or the first predictive content item 145 provided in the first display 140 by 50%. The vehicle based data processing system 110 can add the first display 140 to the predictive interface 135 or add the first predictive content item 145 to the first display 140 and thus, increase the size of the fourth display 140 or the first predictive interface by 100%. The vehicle based data processing system 110 can increase the size of a display 140 or a predictive content item 135 in a range from 5% to 100%. The vehicle based data processing system 110 can modify the dimensions or pixel value for one or more displays 140 responsive to an input or interaction from a user of the vehicle 107. The interaction can include a new user entering the vehicle 107, a touch input through at least one display 140, an input through an input device 165 of the vehicle 107 or a voice command. For example, the vehicle based data processing system 110, responsive to an input or interaction, can generate instructions to decrease the size of the at least one display 140 providing and increase the size of at least one other display 140 allocated to the predictive interface 135. The vehicle based data processing system 110, responsive to an input or interaction, can generate instructions to decrease the pixel value allocated to at least one display 140 and increase the pixel value allocated to at least one other display 140 allocated to the predictive interface 135. The vehicle based data processing system 110 can apply the instructions to the respective displays 140 to modify the size of the respective displays 140. The vehicle based data processing system 110 can store the instructions in the memory 130 for later use or to update a user profile 125 of a user requested the modification to the display layout 400.

The vehicle based data processing system 110 can modify a position or location of one or more displays 140 of the information cluster 105 or the predictive interface 135 responsive to an input or interaction. For example, the vehicle based data processing system 110, responsive to an input or interaction, can generate instructions to relocate the predictive interface 135 from a first portion 210 to a third portion 220 of the information cluster 105. The vehicle based data processing system 110, responsive to an input or interaction, can generate instructions to relocate the entrainment system 132 provided in the display 140 of the third portion 220 of the information cluster105 from the third portion 220 to the first portion 210. The vehicle based data processing system 110 can apply the instructions to information cluster 105 to move the predictive interface 135 from the first portion 210 to the third portion 220. The vehicle based data processing system 110 can apply the instructions to information cluster 105 to move the entertainment system 132 data from the third portion 220 to the first portion 210.

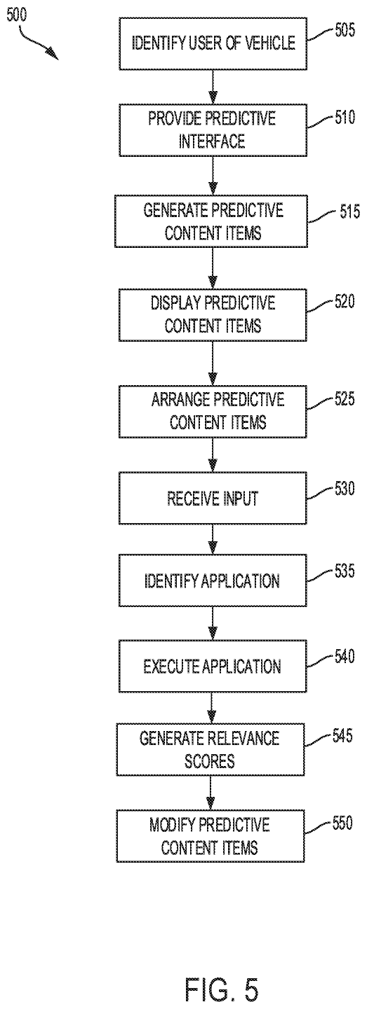

FIG. 5, among others, depicts a method 500 for providing predictive content items 145 within a vehicle information cluster 105. The method 500 can include identifying a user of the vehicle 107 (ACT 505). The vehicle 107 can include an information cluster 105 having a vehicle based data processing system 110. The vehicle based data processing system 110 can determine at least one user of the vehicle 107. For example, responsive to activating or turning on the vehicle or activating the information cluster 105, the vehicle based data processing system 110 can determine how many users are in the vehicle 107 and properties of the users (or user) in the vehicle 107. A user can refer to a driver or passenger in the vehicle 107. The vehicle based data processing system 110 can couple with one or more sensors within the vehicle to determine how many users are in the vehicle 107. For example, the seats in the vehicle can include sensors and the sensors can transmit a signal to the vehicle based data processing system 110 to indicate when a user is sitting in or on the respective seat. The vehicle based data processing system 110 can use the seat data to identify whether the user is a driver or passenger of the vehicle 107 or a combination of a driver and one or more passengers of the vehicle 107.

The vehicle based data processing system 110 can detect the presence or couple with one or more devices of a user of the vehicle 107 to detect the user of the vehicle 107. For example, the vehicle based data processing system 110 can detect the presence of a cell phone or hand held computing device and identify a user of the cell phone or hand held computing device. The vehicle based data processing system 110 can detect the presence of a key, electronic key, or key fob of the vehicle 107. The vehicle based data processing system 110 can use the device data to identify the corresponding user of the device. For example, the vehicle based data processing system 110 can receive user data from the device when the device couples with the information cluster 105. The vehicle based data processing system 110 can store user profiles and use the device data to identify the user of the respective device.

The method 500 can include providing a predictive interface 135 (ACT 510). For example, the vehicle based data processing system 110 can generate, display or provide the predictive interface 135 within in at least one display 140 of the information cluster 105. The vehicle based data processing system 110 can generate instructions to display the predictive interface 135 within the information cluster 105. The position or location of the predictive interface 135 can be selected based at least in part on the user of the vehicle 107. For example, the vehicle based data processing system 110 can retrieve a preferred display position for the predictive interface 135 stored in the memory 130 of the vehicle based data processing system 110. The instructions generated by the vehicle based data processing system 110 can identify at least one display 140 to display the predictive interface 135 and a position of the display 140 to display the predictive interface 135. The vehicle based data processing system 110 can execute the instructions to display the predictive interface 135 within the information cluster 105.

The method 500 can include generating predictive content items 145 (ACT 515). For example, the method 500 can include generating, by the vehicle based data processing system 110, a plurality of predictive content items 145 corresponding to a user of a vehicle 107. The vehicle based data processing system 110 can include a prediction module 115 having a prediction algorithm. Generating the predictive content items 145 can include the vehicle based data processing system 110 executing the prediction module 115 to generate predictive content items 145 corresponding to one or more users of the vehicle 107. The prediction module 115 can execute the prediction algorithm having a set of instructions to identify at least one user profile 125 of the plurality of user profiles 125 stored in the database 120. The prediction algorithm can identify systems 132 of the vehicle 107 the user interacts with and actions (e.g., navigation location, make phone call, order coffee) the user took when interacting with the respective system 132. The prediction module 115 can execute the prediction algorithm to generate predictive actions corresponding to the users past history using the data from the corresponding user profile. The prediction module 115 can link the predictive actions with at least one predictive content item 145.

The prediction module 115 can provide the plurality of content items 145 having links with predictive actions to the vehicle based data processing system 110. Generating predictive content items 145 can include the vehicle based data processing system 110 generating relevance scores for each of the plurality of predictive content items 145. For example, the vehicle based data processing system 110 can determine relevance scores for the different predictive content item 145 based in part on at least one of: a time value, a location of the vehicle 107, a pattern profile of the user of the vehicle 107, and a user profile of the user of the vehicle 107. The relevance scores can correspond to a frequency of use or frequency of interaction with the respective content item 145. The vehicle based data processing system 110 can assign each of the plurality of content items 145 a relevance score. The vehicle based data processing system 110 can rank the plurality of content items 145 based on the relevance scores. The vehicle based data processing system 110 can store the relevance scores for each of the plurality of content items 145 in entries in the memory 130. Generating the predictive content items 145 can include the vehicle based data processing system 110 determining at least one user of the vehicle 107. The vehicle based data processing system 110 can identify at least one user profile 125 corresponding to the user of the vehicle 107. The user profile 125 can include predictive content items that the user interacts with. The user profile 125 can include rankings for the predictive content items that the user interacts with based in part on relevance scores. The vehicle based data processing system 110 can extract predictive content items 145 from the user profile 125 of the user of the vehicle 107. The vehicle based data processing system 110 can populate the plurality of displays 140 of the predictive interface 135 with the predictive content items 145 from the user profile 125 of the user of the vehicle 107. The predictive content items 145 can be linked with or associated with third party servers 150 or third party applications 155 hosted by third party servers 150. The vehicle based data processing system 110 can request or extract data corresponding to the predictive content items 145 from the user profile 125 of the user of the vehicle 107 from the third party server 150 or third party application 155 identified in the user profile 125. The vehicle based data processing system 110 can receive the data from the third party server 150 or the third party application 155. The vehicle based data processing system 110 can generate predictive content items 145 based on the data from the third party server 150 or the third party application 155. For example, the data can indicate predictive content that the user of the vehicle may be interested in based in part on previous interactions with the third party server 150 or third party application 155. The vehicle based data processing system 110 can populate the plurality of displays 140 of the predictive interface 135 with the predictive content items 145 corresponding to the data from the third party server 150 or the third party application 155.

The method 500 can include displaying the predictive content items 145 (ACT 520). For example, the method 500 can include displaying, by the predictive interface 135, the plurality of predictive content items 145 within the plurality of displays 140. Each of the displays 140 can display at least one predictive content item 145 from the plurality of predictive content items 145. The vehicle based data processing system 110 can identify a number of predictive content items 145 to be displayed within the displays 140. The number of predictive content items 145 can be selected based at least in part on the number of displays 140. The vehicle based data processing system 110 can allocate a number of displays 140 of the information cluster 105 to the predictive interface 135. For example, the predictive interface 135 can be allocated five displays 140 and the vehicle based data processing system 110 can generate instructions to display five predictive content items 145 within the five displays 140 of the predictive interface 135. The vehicle based data processing system 110 can select the predictive content items 145 based in part on the relevance scores assigned to the predictive content items 145. The vehicle based data processing system 110 can select the predictive content items 145 having the highest relevance score for the user or users of the vehicle 107. In the five display example, the vehicle based data processing system 110 can select the five predictive high content items 145 having the five highest relevance scores. The vehicle based data processing system 110 can execute the instructions to display the predictive content items 145 having the highest relevance scores in the displays 140 allocated to the predictive interface 135.

The vehicle based data processing system 110 can allocate a single display 140 for the predictive interface 135. The vehicle based data processing system 110 can generate two or more displays 140 for the predictive interface 135. The vehicle based data processing system 110 can determine a number of displays 140 to allocate to the predictive interface 135 based in part on the identified user of the vehicle 107. For example, the user may have a preferred display layout stored in the memory 130 of the vehicle based data processing system 110. Responsive to identifying the user of the vehicle 107, the vehicle based data processing system 110 can retrieve the preferred display layout for the user and allocate a number of displays 140 corresponding to the preferred display layout. The vehicle based data processing system 110 can determine a number of displays 140 to allocate to the predictive interface 135 based in part on a standard display layout. For example, the predictive interface 135 or information cluster 105 can include a standard display layout having a predetermined number of displays 140 that the vehicle based data processing system 110 generates when the vehicle 107 is activated or turned on.

Displaying the predictive content items 145 can include the vehicle based data processing system 110 generating the displays 140 such that each of the displays 140 can be visible or at least partially visible within the vehicle 107 with respect to a viewpoint of a user of the vehicle 107. For example, the vehicle based data processing system 110 can generate each of the displays 140 of the predictive interface 135 having the same visibility (e.g., same dimensions, same pixel value). The vehicle based data processing system 110 can generate one or more of the displays 140 of the predictive interface 135 having a different visibility (e.g., same dimensions, same pixel value) from one or more other displays 140. For example, the vehicle based data processing system 110 can generate a first display 140 having a greater visibility within the vehicle 107 than the other displays 140 of the predictive interface 135. For example, the first display 140 can have a larger diameter or be assigned more pixels than the other displays 140 of the predictive interface 135.

The vehicle based data processing system 110 can determine dimensions (e.g., length, width, diameter) of the display 140 allocated to the predictive interface 135. The dimensions can be selected based in part on a number of predictive content items 145 to be provided within the predictive interface 135. The vehicle based data processing system 110 can determine a number of pixels (e.g., pixel value) to be allocated or assigned to the displays 140 of the predictive interface 135. The pixel value can be selected based in part on a number of predictive content items 145 to be provided within the predictive interface 135. The vehicle based data processing system 110 can dynamically modify the dimensions or pixel value for the displays 140 allocated to the predictive interface 135. For example, responsive to an interaction or input from a user of the vehicle, the vehicle based data processing system 110 can dynamically increase the size or dynamically increase the pixel value for the displays 140 allocated to the predictive interface 135. Responsive to an interaction or input from a user of the vehicle, the vehicle based data processing system 110 can dynamically decrease the size or dynamically decrease the pixel value for the displays 140 allocated to the predictive interface 135.

The method 500 can include arranging the predictive content items 145 (ACT 525). For example, the method 500 can include arranging, by the vehicle based data processing system 110, the plurality of predictive content items 145 within the displays 140 based on a first relevance score assigned to each of the predictive content items 145 of the plurality of predictive content items 145. The first relevance score can correspond to an initial relevance score assigned to each of the predictive content items 145. The first relevance score can correspond to an initial relevance score assigned to each of the predictive content items 145 when the vehicle 107 is activated, turned-on or otherwise in use. The vehicle based data processing system 110 can select which display 140 will display which predictive content items 145 based on the relevance scores. For example, the vehicle based data processing system 110 can arrange the predictive content items 145 in order from highest relevance score to lowest relevance score of the predictive content items 145 selected to be displayed within the predictive interface 135. The vehicle based data processing system 110 can arrange the predictive content items 145 in a left to right direction with the left most display 140 providing the predictive content item 145 with the highest relevance score and the right most display 140 providing the predictive content item 145 with the lowest relevance score of the relevance scores of the predictive content items 145 selected for display within the predictive interface 135. The vehicle based data processing system 110 can arrange the predictive content items 145 in a right to left eft to direction with the right most display 140 providing the predictive content item 145 with the highest relevance score and the left most display 140 providing the predictive content item 145 with the lowest relevance score of the relevance scores of the predictive content items 145 selected for display within the predictive interface 135. The vehicle based data processing system 110 can arrange the predictive content items 145 in a top to bottom direction with the top or first display 140 providing the predictive content item 145 with the highest relevance score and the bottom or last right display 140 providing the predictive content item 145 with the lowest relevance score of the relevance scores of the predictive content items 145 selected for display within the predictive interface 135. The vehicle based data processing system 110 can arrange the predictive content items 145 in a bottom to top direction with the bottom or last display 140 providing the predictive content item 145 with the highest relevance score and the top or first display 140 providing the predictive content item 145 with the lowest relevance score of the relevance scores of the predictive content items 145 selected for display within the predictive interface 135. The arrangement of the predictive content items 145 can vary beyond these examples. The arrangement of the predictive content items 145 can be generated by the vehicle based data processing system based in part on the dimensions and layout of the information cluster 105.

The method 500 can include receiving an input (ACT 530). For example, the method 500 can include receiving, by the vehicle based data processing system 110, a first input corresponding to a first predictive content item 145 of the plurality of predictive content items 145. The input can be received through an input device 165 of the information cluster 105. For example, the input device 165 can communicatively couple with the vehicle based data processing system 110, for example, through a wireless connection. The input device 165 can couple with the vehicle based data processing system 110, for example, through a wired connection. The input device 165 can include buttons or keypads to generate a signal responsive to contact. The signals can correspond to a directional input or motion input to interact with one or more of the predictive content items 145 provided within a respective display 140. The signals can include a selection of at least one predictive content item 145 provided within a display 140. For example, the signals can include a selection through a first predictive content item 145 corresponding to a phone menu provided in a first display 140 to initiate a phone call through a system 132 of the vehicle 107 or a phone (e.g., mobile phone) of a user of the vehicle 107. The signals can include a direction (e.g., right, left, up, down) to relocate or slide predictive content items 145 within the predictive interface 135 from a first display 140 to a second display 140.

The input can be received through at least one display 140 of the predictive interface 135. For example, the displays 140 can include or correspond to a touch screen. The vehicle based data processing system 110 can identify a touch signal corresponding to the interaction or input. The touch signal can represent of a position within a first display 140 of the predictive interface corresponding to at least one system 132 of the vehicle 107. The touch signal can be responsive to contact with the position within the first display 140. The position can correspond to or be linked with the predictive content item 145 provided within the first display 140. For example, the displays 140 can receive an input through contact with a surface of the respective display 140. The vehicle based data processing system 110 can detect a horizontal and vertical orientation of the contact on the display 140. The vehicle based data processing system 110 can map or identify the location of the contact using the horizontal and vertical orientation data. The vehicle based data processing system 110 can determine what predictive content item 145 is provided within the identified location of the contact.

The method 500 can include identifying an application 155 (ACT 535). For example, the method 500 can include identifying, by the vehicle based data processing system 110, a first application 155 of a plurality of applications 155. The first application 155 can correspond to a first predictive content item 145. Responsive to identifying the selected predictive content item 145, the vehicle based data processing system 110 can determine if the selected predicted content item 145 is linked with an application 155 and identify which application 155 the predictive content item 145 is linked with. For example, the vehicle based data processing system 110 can link the different systems 132 (e.g., navigation system, a climate control system, an entertainment system, an autonomous drive system, or a phone system) of the vehicle 107 with predictive content items 145. The systems 132 can correspond to a service or product provided by at least one application 155 hosted by an external server 150. Thus, the vehicle based data processing system 110 can link and associate predictive content items 145 with an application 155 or an external server 150 hosting an application 155. For example, the vehicle based data processing system 110 can generate at least one hyperlink for each of the plurality of content items 145 provided within the predictive interface 135. The vehicle based data processing system 110 can generate the plurality of content items 145 such that each of the content items 145 include a hyperlink or are tagged with a hyperlink to redirect a user of the vehicle from the predictive interface 135 to a server 150 corresponding to the respective content item 145. The vehicle based data processing system 110 can generate a request to retrieve content corresponding to a respective predictive content item 145.

The request can identify a third party application 155 corresponding to the predictive content item 145. The request can identify a third party server 150 hosting the third party application 155 corresponding to the predictive content item 145. For example, the vehicle based data processing system 110 can generate the request to retrieve the application 155 from a third party server 150 hosting the respective application 155 or content corresponding to the application 155. The vehicle based data processing system 110 can generate the request responsive to an interaction with the hyperlink of the respective predictive content item 145. The hyperlink can couple the vehicle based data processing system 110 with a third party application 155 hosted by a third party server 150 corresponding to the predictive content item 145.

The method 500 can include executing the application 155 (ACT 540). For example, the method 500 can include executing, by the vehicle based data processing system 110, the first application 155. The vehicle based data processing system 110 can generate instructions to execute the first application 155 using the hardware and software of the vehicle 107. The vehicle based data processing system 110 can download the application 155 from a server 150 to execute the application 155. The vehicle based data processing system 110 can connect to the server 150 hosting the application, for example, through an internet connection or wireless network to execute the application 155 through the respective server 150. For example, the predictive content item 145 can correspond to a coffee application 155 for a local coffee shop. The coffee application can be hosted by a server 150 corresponding to the local coffee shop. The coffee application 155 can provide an interface for someone to order drinks and food through the coffee application 155. The vehicle based data processing system 110 can execute the coffee application 155 to display a menu corresponding to the drinks and food offered by the local coffee shop. A user of the vehicle 107 can order a coffee, for example, using the coffee application 155 provided within the information cluster 105 by the vehicle based data processing system 110.

The method 500 can generate relevance scores (ACT 545). For example, the method 500 can include generating, by the vehicle based data processing system 110, a second relevance score for each of the plurality of predictive content items 145 of the plurality of predictive content items 145 responsive to the execution of the first application 155. The second relevance score can correspond to an updated relevance score, updated with respect to the first or initial relevance score. The vehicle based data processing system 110 can generate new, updated or subsequent relevance scores for the predictive content items 145 subsequent to at least one of the predictive content items 145 being selected. The vehicle based data processing system 110 can assign updated relevance scores to each of the predictive content items 145 displayed within the display 140 of the predictive interface 135. For example, responsive to a first predictive content item 145 having the highest relevance score being selected, the vehicle based data processing system 110 can re-assign updated relevance scores to the remaining predictive content items 145 displayed within the display 140 of the predictive interface 135. The vehicle based data processing system 110 can identify a predictive content item 145 having the next highest relevance score to display within at least one display 140 within the predictive interface 135. The vehicle based data processing system 110 can generate instructions to display the predictive content item 145 having the next highest relevance score responsive to at least one predictive content item 145 being selected.

The method 500 can include modifying the predictive content items 145 (ACT 550). For example, the method 500 can include modifying, the vehicle based data processing system 110, the arrangement of the plurality of predictive content items 145 within the plurality of displays 140 based on the second relevance score assigned to each of the predictive content items 145 of the plurality of predictive content items 145. The vehicle based data processing system 110 can generate instructions to remove a selected predictive content item 145 from the predictive interface 135 responsive to executing the application 155. The vehicle based data processing system 110 can remove the selected predictive content item 145 from at least one display 140 of the predictive interface 135. The vehicle based data processing system 110 can display the predictive content item 145 having the next highest relevance score in at least one display 140 of the predictive interface 135. The vehicle based data processing system 110 can modify arrangement of the predictive content items 145 using the second or updated relevance scores. For example, the vehicle based data processing system 110 can select a display 140 of the predictive interface 135 using the second or updated relevance scores. The vehicle based data processing system 110 can reposition and relocate one or more of the predictive content items 145 within the predictive interface 135 such that the predictive content items 145 are organized and arranged based on the second relevance scores. For example, the vehicle based data processing system 110 can relocate a predictive content item 145 from a first display 140 to a second, different display 140 of the predictive interface 135 responsive to the second relevance scores. The vehicle based data processing system 110 can relocate each of the predictive content items 145 provided within the predictive interface 135 at least one display 140 in a left direction responsive to the second relevance scores. The vehicle based data processing system 110 can relocate each of the predictive content items 145 provided within the predictive interface 135 at least one display 140 in a right direction responsive to the second relevance scores. The vehicle based data processing system 110 can relocate each of the predictive content items 145 provided within the predictive interface 135 down at least one display 140 responsive to the second relevance scores. The vehicle based data processing system 110 can relocate each of the predictive content items 145 provided within the predictive interface 135 up at least one display 140 responsive to the second relevance scores.

The vehicle based data processing system 110 can receive a second input or subsequent input from a user of the vehicle 107. For example, the user can select a second or subsequent predictive content item 145. The vehicle based data processing system 110 can update the prediction module 115 responsive to the second input from the user of the vehicle 107. The vehicle based data processing system 110 can update the prediction module 115 to indicate which predictive content item 145 has been selected responsive to the second or subsequent input. The prediction module 115 can update the prediction algorithm to reflect the interaction of the user of the vehicle 107 with the predictive content item 145 has been selected responsive to the second or subsequent input. The vehicle based data processing system 110 can update relevance scores (e.g., first relevance scores, second relevance scores) for the plurality of predictive content items 145. For example, the vehicle based data processing system 110 can dynamically update relevance scores for the predictive content items 145 responsive to selections, inputs or interactions with the predictive content items 145 displayed within the display 140 of the predictive interface 135. The updated relevance scores can reflect a selection or interaction with one or more of the predictive content items 145 by a user of the vehicle 107. The vehicle based data processing system 110 can select one or more predictive content items 145 if the plurality of predictive content items 145 for display within the plurality of displays 140 based on the modified relevance scores. The vehicle based data processing system 110 can dynamically identify and select new predictive content items 145 from the predictive interface 135 responsive to interactions with the displayed predictive content items 145 of the predictive interface 135. The vehicle based data processing system 110 can dynamically remove predictive content items 145 from the predictive interface 135 responsive to interactions with the displayed predictive content items 145 of the predictive interface 135. The vehicle based data processing system 110 can dynamically update and modify what predictive content items 145 are displayed within the displays 140 of the predictive interface 135 responsive to interactions with the displayed predictive content items 145 of the predictive interface 135 and responsive to modified relevance scores (e.g., dynamically updated scores).

The vehicle based data processing system 110 can receive a second input or subsequent input from a user of the vehicle 107. The second input or subsequent input can correspond to a selected predictive content item 145. The vehicle based data processing system 110 can identify an application 155 corresponding to the selected predictive content item 145. For example, the selected predictive content item 145 can correspond to an entertainment system 132 of the vehicle. The entertainment system 132 can be linked with a music sharing application 155. The vehicle based data processing system 110 can identify the music sharing application 155 corresponding to the selected predictive content item 145 using the database 120. For example, vehicle based data processing system 110 can store the associations between the predictive content items 145 and a system 132 of the vehicle 107 and an application 155 of a server 150 in an entry of the database 120 for the respective predictive content item 145. The vehicle based data processing system 110 can extract the association information responsive to a selection of the one of the predictive content items 145. The vehicle based data processing system 110 can modify a relevance score of a third application 155 responsive to the second input or subsequent input. The vehicle based data processing system 110 can generate relevance scores for systems 132 or applications 155 linked with predictive content items 145. The vehicle based data processing system 110 can assign relevance scores for systems 132 or applications 155 linked with predictive content items 145. The relevance scores for the systems 132 or applications 155 can be the same as the relevance scores assigned to the corresponding to the predictive content item 145. The relevance scores for the systems 132 or applications 155 can be different from the relevance scores assigned to the corresponding to the predictive content item 145. For example, the relevance scores for the systems 132 or applications 155 can be generated based on or in comparison to the other systems 132 or applications 155 linked or associated with predictive content items 145. The vehicle based data processing system 110 can modify a relevance score of the selected predictive content item 145 corresponding to the third application 155 responsive to the second input or subsequent input.

The vehicle based data processing system 110 can compare the relevance score of the third application to a relevance threshold. The relevance threshold can correspond to a value representing a threshold value needed for the vehicle based data processing system 110 to add or include the respective predictive content item 145 to at least one display 140 of the displays 140 of the predictive interface 135. The relevance threshold can correspond to the value of the predictive content item 145 displayed within the displays 140 of the predictive interface 135 having the lowest relevance score. Thus, if a new predictive content item 145 has a relevance score higher than the currently displayed predictive interface 135 having the lowest relevance score, the vehicle based data processing system 110 can add the new predictive content item 145 to at least one display 140 of the predictive interface 135. The vehicle based data processing system 110 can remove a predictive content item 145 of the plurality of content items 145 corresponding to the third application 155 from the plurality of displays 140 responsive to the comparison. For example, the vehicle based data processing system 110 can remove the currently displayed predictive interface 135 having the lowest relevance score responsive to the comparison. If a new predictive content item 145 has a relevance score that is lower than the currently displayed predictive interface 135 having the lowest relevance score, the vehicle based data processing system 110 can ignore the new predictive content item 145 and not update to modify the predictive content items 145 displayed in the displays 140 of the predictive interface 135.

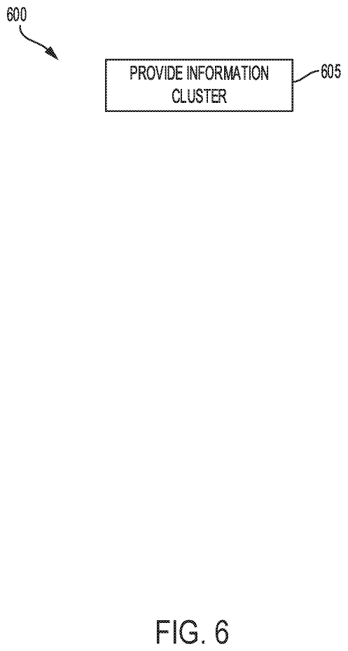

FIG. 6 depicts a method 600. The method 600 can include providing an information cluster 105 of a vehicle 107 (ACT 605). The information cluster 105 can include a vehicle based data processing system 110 to generate a plurality of predictive content items 145 corresponding to a user of a vehicle 107. The information cluster 105 can include a predictive interface 135 communicatively coupled with the vehicle based data processing system 110. The predictive interface 135 can include a plurality of displays 140. Each of the displays can display at least one predictive content item 145 from the plurality of predictive content items 145. The vehicle based data processing system 110 can arrange the plurality of predictive content items 145 within the plurality of displays 140 based on a first relevance score assigned to each of the predictive content items 145 of the plurality of predictive content items 145. The vehicle based data processing system 110 can receive a first input corresponding to a first predictive content item 145 of the plurality of predictive content items 145. The vehicle based data processing system 110 can identify a first application 155 of a plurality of applications 155. The first application 155 can correspond to the first predictive content item 145. The vehicle based data processing system 110 can execute the first application 155. The vehicle based data processing system 110 can generate a second relevance score for each of the predictive content items 145 of the plurality of predictive content items 145 responsive to execution of the first application 155. The vehicle based data processing system 110 can modify the arrangement of the plurality of predictive content items 145 within the plurality of displays 140 based on the second relevance score assigned to each of the predictive content items 145 of the plurality of predictive content items 145.

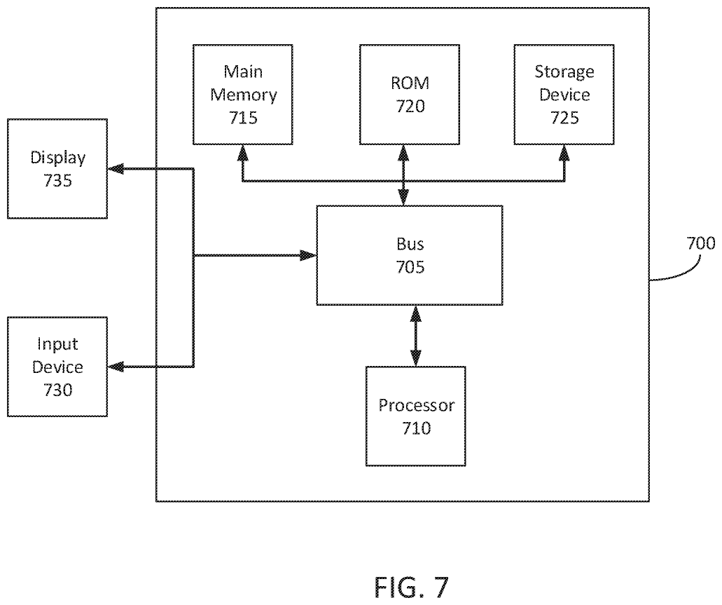

FIG. 7 is a block diagram of an example computer system 700. The computer system or computing device 700 can include or be used to implement the information cluster 105, or its components such as the vehicle based data processing system 110 or the predictive interface 135. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be or include the memory 130. The main memory 715 can also be used for storing predictive content items 145, user profiles 125, application data, server data, position information, vehicle information, command instructions, vehicle status information, environmental information within or external to the vehicle, road status or road condition information, or other information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions. The storage device 725 can include or be part of the memory 130.

The computing system 700 may be coupled via the bus 705 to a display 735, such as a liquid crystal display, or active matrix display, for displaying information to a user such as a driver of the vehicle 107. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 (e.g., on a vehicle dashboard) can be part of the information cluster 105, the predictive interface 135, or displays 140, as well as part of the vehicle 107, for example.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., predictive interface 135), and the information cluster 105. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example, the vehicle based data processing system can communicatively couple with more than one display module within a vehicle and generate multiple windows for each of the display modules. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A vehicle information system, comprising:
a vehicle based data processing system to generate a plurality of predictive content items corresponding to a user of a vehicle; and
a predictive interface communicatively coupled with the vehicle based data processing system, the predictive interface having a plurality of displays, each of the displays displaying at least one predictive content item from the plurality of predictive content items;
the vehicle based data processing system to:
arrange the plurality of predictive content items within the plurality of displays based on a first relevance score assigned to each of the predictive content items of the plurality of predictive content items;
receive a first input corresponding to a first predictive content item of the plurality of predictive content items;
identify a first application of a plurality of applications, the first application corresponding to the first predictive content item;
execute the first application;
generate a second relevance score for each of the predictive content items of the plurality of predictive content items that remain displayed within the plurality of displays responsive to execution of the first application; and
modify the arrangement of the plurality of predictive content items within the plurality of displays based on the second relevance score assigned to each of the predictive content items of the plurality of predictive content items.

2. The system of claim 1, comprising:
the vehicle based data processing system to:
generate a user profile for at least one passenger within the vehicle; and
generate the plurality of predictive content items based on the user profile of the at least one passenger within the vehicle.

3. The system of claim 1, comprising:
each of the plurality of applications corresponding to at least one system of the vehicle.

4. The system of claim 1, comprising:
the vehicle based data processing system having a database, and the vehicle based data processing system to:
generate a plurality of user profiles corresponding for a plurality of users of the vehicle, the plurality of users including drivers and passengers; and
generate predictive content items for each of the plurality of user profiles; and
maintain the plurality of user profiles having predictive content items in the database.

5. The system of claim 1, comprising:
the vehicle based data processing system to:
determine a user of the vehicle;
identify at least one user profile corresponding to the user of the vehicle;
extract predictive content items from the user profile of the user of the vehicle; and
populate the plurality of displays of the predictive interface with the predictive content items from the user profile of the user of the vehicle.

6. The system of claim 1, comprising:
the vehicle based data processing system to:
determine a user of the vehicle;
generate relevance scores for predictive content items corresponding to the user of the vehicle, the relevance scores based on at least one of: a time value, a location of the vehicle, a pattern profile of the user of the vehicle, and a user profile of the user of the vehicle; and
arrange the predictive content items within the plurality of displays of the predictive interface based on the relevance scores.

7. The system of claim 1, comprising:
the vehicle based data processing system having a prediction module, the vehicle based data processing system to:
receive a second input from a user of the vehicle;
update the prediction module responsive to the second input from the user of the vehicle;
modify, using the prediction module, the relevance scores for the plurality of predictive content items; and
select one or more predictive content items of the plurality of predictive content items for display within the plurality of displays based on the modified relevance scores.

8. The system of claim 1, comprising:
the vehicle based data processing system having a prediction module, the vehicle based data processing system to:
receive a second input from a user of the vehicle;
update the prediction module responsive to the second input from the user of the vehicle;
modify, using the prediction module, the relevance scores for the plurality of predictive content items;
remove a first one or more predictive content items of the plurality of predictive content items from the plurality of displays based on the modified relevance scores; and
add a second one or more predictive content items of the plurality of predictive content items from the plurality of displays based on the modified relevance scores.

9. The system of claim 1, comprising:
the vehicle based data processing system to:
determine a user of the vehicle;
identify at least one user profile corresponding to the user of the vehicle;
extract data from a third party server identified in the user profile of the user of the vehicle;
generate predictive content items based on the data from the third party server; and
populate the plurality of displays of the predictive interface with the predictive content items corresponding to the data from the third party server.

10. The system of claim 1, comprising:
the vehicle based data processing system to:
detect the vehicle transitioning from an inactive state to an active state; and
populate the plurality of displays of the predictive interface with the predictive content items responsive to the detection.

11. The system of claim 1, comprising:
the vehicle based data processing system having a prediction module, the vehicle based data processing system to:
receive a second input from a user of the vehicle;
modify, by the prediction module, a relevance score of a third application responsive to the second input;
compare, by the prediction module, the relevance score of the third application to a relevance threshold; and
remove a predictive content item of the plurality of predictive content items corresponding to the third application from the plurality of displays responsive to the comparison.

12. The system of claim 1, comprising:
a display layout having a plurality of displays visible within the vehicle; and
the predictive interface provided within at least one of the plurality of displays when the vehicle is active.

13. The system of claim 1, comprising:
the predictive interface disposed within a dashboard of the vehicle.

14. The system of claim 1, comprising:
the predictive interface disposed within a console of the vehicle.

15. A method of providing predictive content items within a vehicle information cluster, the method comprising:
generating, by a vehicle based data processing system, a plurality of predictive content items corresponding to a user of a vehicle;
displaying, by a predictive interface, the plurality of predictive content items within a plurality of displays, each of the displays displaying at least one predictive content item from the plurality of predictive content items;
arranging, by the vehicle based data processing system, the plurality of predictive content items within the plurality of displays based on a first relevance score assigned to each of the predictive content items of the plurality of predictive content items;
receiving, by the vehicle based data processing system, a first input corresponding to a first predictive content item of the plurality of predictive content items;
identifying, by the vehicle based data processing system, a first application of a plurality of applications, the first application corresponding to the first predictive content item;
executing, by the vehicle based data processing system, the first application;
generating, by the vehicle based data processing system, a second relevance score for each of the predictive content items of the plurality of predictive content items remaining displayed within the plurality of displays responsive to execution of the first application; and
modifying, by the vehicle based data processing system, the arrangement of the plurality of predictive content items within the plurality of displays based on the second relevance score assigned to each of the predictive content items of the plurality of predictive content items.

16. The method of claim 15, comprising:
determining, by the vehicle processing system, a user of the vehicle;
identifying, by the vehicle processing system, at least one user profile corresponding to the user of the vehicle;
extracting, by the vehicle processing system, predictive content items from the user profile of the user of the vehicle; and
populating, by the vehicle processing system, the plurality of displays of the predictive interface with the predictive content items from the user profile of the user of the vehicle.

17. The method of claim 15, comprising:
receiving, by the vehicle processing system, a second input from a user of the vehicle;
updating, by the vehicle processing system, the prediction module responsive to the second input from the user of the vehicle;
modifying, by the prediction module, the relevance scores for the plurality of predictive content items; and
selecting, by the vehicle processing system, one or more predictive content items of the plurality of predictive content items for display within the plurality of displays based on the modified relevance scores.

18. The method of claim 15, comprising:
determining, by the vehicle processing system, a user of the vehicle;
identifying, by the vehicle processing system, at least one user profile corresponding to the user of the vehicle;
extracting, by the vehicle processing system, data from a third party server identified in the user profile of the user of the vehicle;
generating, by the vehicle processing system, predictive content items based on the data from the third party server; and
populating, by the vehicle processing system, the plurality of displays of the predictive interface with the predictive content items corresponding to the data from the third party server.

19. The method of claim 15, comprising:
receiving, by the vehicle processing system, a second input from a user of the vehicle;
modifying, by a prediction module of the vehicle processing system, a relevance score of a third application responsive to the second input;
comparing, by the prediction module, the relevance score of the third application to a relevance threshold; and
removing, by the vehicle processing system, a predictive content item of the plurality of predictive content items corresponding to the third application from the plurality of displays responsive to the comparison.

20. A vehicle, comprising:
a vehicle information system, the system comprising:
a vehicle based data processing system to generate a plurality of predictive content items corresponding to a user of a vehicle; and
a predictive interface communicatively coupled with the vehicle based data processing system, the predictive interface having a plurality of displays, each of the displays displaying at least one predictive content item from the plurality of predictive content items;
the vehicle based data processing system to:
arrange the plurality of predictive content items within the plurality of displays based on a first relevance score assigned to each of the predictive content items of the plurality of predictive content items;
receive a first input corresponding to a first predictive content item of the plurality of predictive content items;
identify a first application of a plurality of applications, the first application corresponding to the first predictive content item;
execute the first application;
generate a second relevance score for each of the predictive content items of the plurality of predictive content items that remain displayed within the plurality of displays responsive to execution of the first application; and
modify the arrangement of the plurality of predictive content items within the plurality of displays based on the second relevance score assigned to each of the predictive content items of the plurality of predictive content items.
